(19) United States
(12) Patent Application Publication
(10) Pub. No.: US 2007/0280555 A1
(43) Pub. Date: Dec. 6, 2007

(54) Image registration based on concentric image partitions

(76) Inventor: Mei Chen, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/445,002

(22) Filed: Jun. 1, 2006

(51) Int. Cl. G06K 9/32; G06K 9/40

(52) U.S. Cl. 382/294; 382/275

(57) ABSTRACT

Methods, systems and machine readable media storing machine-readable instructions for processing images are described. In one aspect, each of the images is divided into a set of corresponding non-overlapping concentric partitions. Each of the partitions includes a respective set of pixels distributed about a central point in the corresponding image. Motion vectors between corresponding partitions of respective pairs of the images are determined. Ones of the images are warped to a reference coordinate system based on the motion vectors.

### BACKGROUND

Image registration is a process of mapping misaligned images into a common coordinate system. The result of the image registration process is a set of spatially aligned images that may be compared or integrated for a wide variety of different applications, including computer vision, pattern recognition, medical image analysis, and remote sensing data fusion. In general, the process of registering two images involves determining one or more spatial transformations that map points in one image to corresponding points in the other image. The transformations may be global or local. Global transformations map all the points in an image in the same way. Local transformations, on the other hand, apply only to spatially local regions of an image.

Optical lenses introduce nonlinear radial distortion in the images that are captured using such lenses. The prevalence and significance of lens distortion in captured images is increasing with the increasing popularity of smaller and cheaper image capture devices, which use smaller and cheaper optical lenses. Lens distortion adversely affects the precision with which images can be registered. Although a wide variety of different image registration approaches have been developed, none of these approaches specifically addresses the misregistration effects caused by radial lens distortion.

What are needed are efficient and effective methods and systems for registering images in ways that reduce the misregistration effects of lens distortion.

### SUMMARY

The invention features methods, systems and machine readable media storing machine-readable instructions for processing images.

In one aspect of the invention, each of the images is divided into a set of corresponding non-overlapping concentric partitions. Each of the partitions includes a respective set of pixels distributed about a central point in the corresponding image. Motion vectors between corresponding partitions of respective pairs of the images are determined. Ones of the images are warped to a reference coordinate system based on the motion vectors.

Other features and advantages of the invention will become apparent from the following description, including the drawings and the claims.

### DESCRIPTION OF DRAWINGS

FIG. 1 is a block diagram of an embodiment of an image processing system.

FIG. 2 is a flow diagram of an embodiment of a method of processing images to produce warped images that are registered in a reference coordinate system.

FIGS. 3-5 are diagrammatic views of different sets of non-overlapping concentric partitions into which images may be divided in accordance with embodiments of the invention.

FIG. 6 is a block diagram of an embodiment of the image processing system shown in FIG. 1 that includes an image pyramid generation module.

FIG. 7 is a flow diagram of an embodiment of a method of determining motion vectors between corresponding partitions of respective pairs of images.

FIG. 8 is a diagrammatic view of a local intensity smoothing filter being applied to local regions of a warped image corresponding to concentric partition boundaries.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Overview

The image processing embodiments that are described in detail below are able to register images in ways that reduce the misregistration effects of radial lens distortion. In these embodiments, the images are warped to a common reference coordinate system in accordance with motion vectors that are determined for non-overlapping concentric partitions of the images. The concentric image partitions approximate pixel regions in the images that are similarly affected by the dominant type of radial distortion that is caused by typical optical lenses. In this way, the embodiments that are described herein are able to efficiently and effectively achieve accurate image registration in the presence of lens distortion without requiring pixel-wise motion computation.

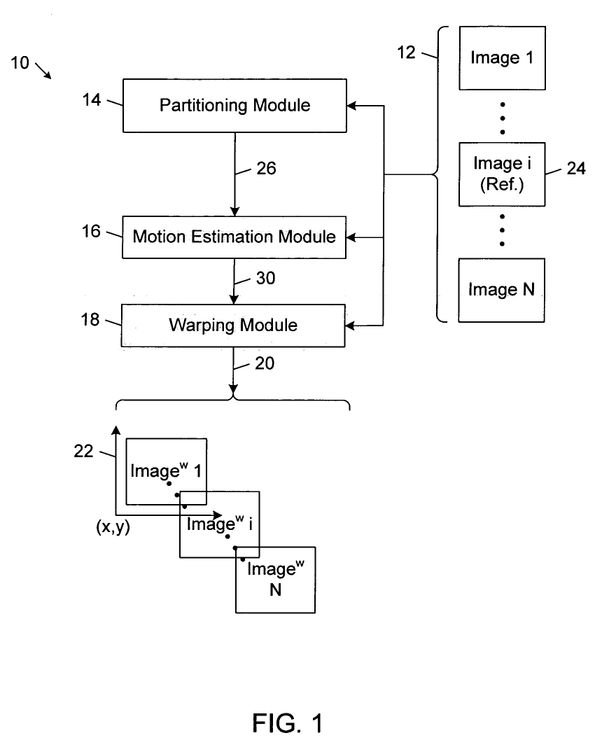

FIG. 1 shows an embodiment of a system 10 for processing a sequence of images 12. The system 10 includes a partitioning module 14, a motion estimation module 16, and a warping module 18. The system 10 is configured to produce from the sequence of images 12 a set of images 20 that have been warped to a reference coordinate system 22.

In general, the modules 14-18 of system 10 are not limited to any particular hardware or software configuration, but rather they may be implemented in any computing or processing environment, including in digital electronic circuitry or in computer hardware, firmware, device driver, or software. For example, in some implementations, these modules 14-18 may be embedded in the hardware of any one of a wide variety of digital and analog electronic devices, including desktop and workstation computers, digital still image cameras, digital video cameras, printers, scanners, and portable electronic devices (e.g., mobile phones, laptop and notebook computers, and personal digital assistants).

In some implementations, computer process instructions for implementing the modules 14-18 and the data generated by the modules 14-18 are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and CD/DVD-ROM.

The images 12 may correspond to an image sequence that was captured by an image sensor (e.g., a video image sequence or a still image sequence) or a processed version of such an image sequence. For example, the images 12 may consist of a sampling of the images selected from an original multiple exposure image sequence that was captured by an image sensor or a compressed or reduced-resolution version of such a sequence. In this case, the warped images may be combined to form an output image that has a higher dynamic range than the images 12. In some cases, at least some of the images correspond to displaced images of the same scene. In these cases, the warped images 20 may be combined into an output image that has a higher spatial resolution than the images 12.

In the illustrated embodiments, the warped images 20 are produced from a selected set of one or more of the images 12, including one image 24 that is designated the “reference image” (e.g., “Image i” in FIG. 1) and one or more images that neighbor the reference image 24 in the sequence. Neighboring images are images within a prescribed number of images of each other in an image sequence, which may be ordered in accordance with an application-specific parameter, such as capture time or exposure level.

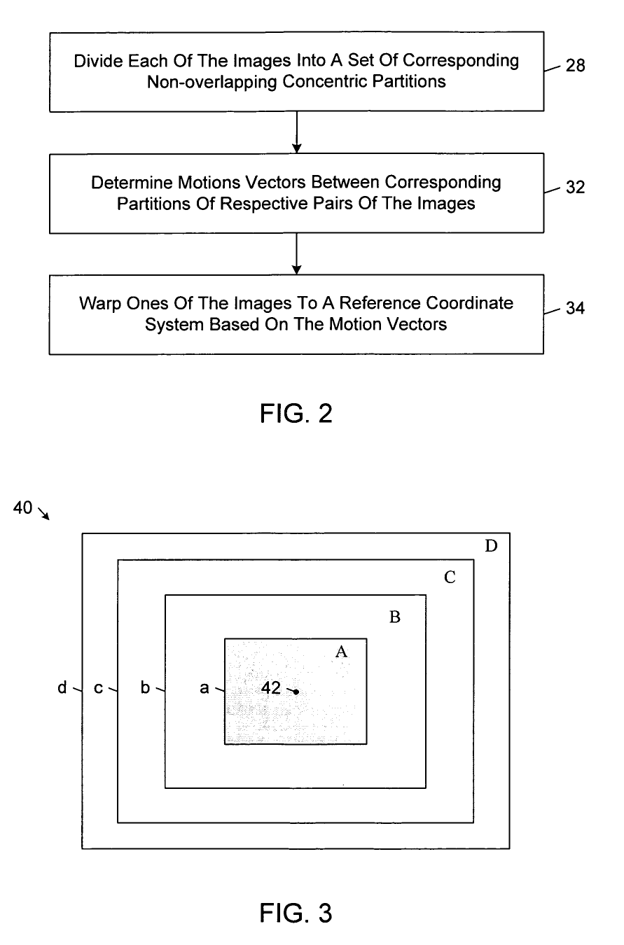

FIG. 2 shows a flow diagram of an embodiment of a method in accordance with which image processing system 10 processes the images 12 to produce the warped images 20.

The partitioning module 14 divides each of the images 12 into a set of corresponding non-overlapping concentric partitions 26 (shown by an arrow in FIG. 1) (FIG. 2, block 28). As explained in detail below, each of the partitions 26 includes a respective set of pixels that are distributed about a central point in the corresponding image. Each set of pixels may correspond to a single continuous region of the corresponding image or to multiple discrete regions of the corresponding image.

The motion estimation module 16 determines motion vectors 30 (shown by an arrow in FIG. 1) between corresponding partitions 26 of respective pairs of the images 12 (FIG. 2, block 32). In some implementations, each of the motion vectors 30 maps the pixels of a respective partition of one of the neighboring image to pixels of a corresponding partition of the reference image 24.

The warping module 18 warps ones of the images 12 to the reference coordinate system 22 (shown in FIG. 1) based on the motion vectors 30 (FIG. 2, block 34). In some embodiments, the reference coordinate system 22 corresponds to the coordinate system of the designated reference image 24. In these embodiments, there is no need for the warping module 18 to warp the reference image 24 to the reference coordinate system 22; instead, the warping module 18 “warps” the reference image 24 by simply passing the reference image 24 through to the output of the warping module 18 (or the next processing module, if present). With respect to these embodiments, the reference image and the neighboring images that are output from the warping module are referred to herein as “warped images”. In other embodiments, the reference coordinate system 22 does not correspond to the coordinate system of the reference image 24. For example, the reference coordinate system 22 may have a spatial orientation with respect to the scene that is different from the coordinate system of the reference image 24, or the reference coordinate system 22 may have a different spatial resolution than the coordinate system of the reference image 24. In these other embodiments, the warping module 18 warps all the images 12 to the reference coordinate system 22. With respect to these embodiments, the reference image and the neighboring images that are output from the warping module also are referred to herein as “warped images”.

### II. Dividing Images into Respective Sets of Corresponding Non-Overlapping Concentric Partitions

As explained above, the partitioning module 14 divides each of the images 12 into a set of corresponding non-overlapping concentric partitions 26, where each of the partitions 26 includes a respective set of pixels that are distributed about a central point in the corresponding image. As used herein, the “central point” of an image corresponds to a pixel location in a central region of the image. The central point may correspond to, for example, the centroid of the image or the center of symmetry of the image or some other point at or near the center of the image. The concentric image partitions approximate pixel regions in the images that are similarly affected by the dominant type of radial distortion that is caused by typical optical lenses.

In some embodiments, each of the partitions comprises a respective set of pixels that are located in the corresponding image at respective coordinates whose average coincides with the central point in the corresponding image. In these embodiments, each of the images is divided so that the corresponding partitions have different respective average pixel distances from the central point in the corresponding image. The partitions typically are demarcated by a series of boundaries that are concentric about the central points of the corresponding images. In general, each of the partition boundaries may correspond to the boundaries of any type of regular or irregular closed plane figure, including polygonal shapes (e.g., rectangles, squares, pentagons, hexagons, et seq.), elliptical shapes (e.g., ellipses, circles, and ovals), and arbitrary shapes. The shapes of the set of boundaries demarcating the partitions of any of the images 12 may be substantially the same or substantially different.

In some embodiments, each set of partitions of an image is demarcated by a series of boundaries having successively larger average distances from the central point of the corresponding image. In these embodiments, the average distance of each successively larger one of the boundaries differs from the average distance of an adjacent preceding boundary in the series by a respective amount that decreases with each successively larger one of the boundaries in the series. This feature of these embodiments enables the resulting partitions to better model pixel regions in the images that are similarly affected by the dominant type of radial distortion that is caused by typical optical lenses.

FIGS. 3-5 show different respective sets of non-overlapping concentric partitions into which the images 12 may be divided in accordance with embodiments of the invention.

FIG. 3 shows an embodiment of a set of four partitions A, B, C, D into which an image 40 is divided. In this embodiment, the four partitions A-D are demarcated by a series of concentric rectangular boundaries a, b, c, d, where boundary d corresponds to the outer edges of the image 40. Each of the partitions A-D includes a respective set of pixels that are located in the image 40 at respective coordinates whose average coincides with a central point 42 (e.g., the centroid) in the image 40. The partitions A-D have different respective average pixel distances ( P̅_{A}, P̅_{B}, P̅_{C}, P̅_{D}) from the central point in the image 40, where

$${\overline{P}}_{k} = \frac{1}{{M}_{k}} \cdot {\sum }_{j = 1}^{{M}_{k}} Dist ( {P}_{k , j} , {P}_{0} ) \qquad ( 1 )$$

where Pₖⱼ=Pₖ(xⱼ,yⱼ) represents the coordinates of the j^{th} pixel in partition k and

$$Dist ( {P}_{k} ( {x}_{j} , {y}_{j} ) , {P}_{0} ( {x}_{0} , {y}_{0} ) ) = \sqrt{{( {x}_{j} - {x}_{0} )}^{2} - {( {y}_{j} - {y}_{0} )}^{2}} \qquad ( 2 )$$

where k ∈ {A,B,C,D}, Mₖ is the number of points in partition k, P_{k,j} is the location of the j^{th} point in partition k, and P₀ is the location of the central point 42.

The partitions A-D correspond to respective regions of the image 40 that are demarcated by the series of boundaries a, b, c, d, which are concentric about the central point 42. In the embodiment shown in FIG. 3, the series of boundaries a-d have successively larger average distances from the central point 42. That is:

B̅ₐ< B̅_{b}< B̅_{c}< B̅_{d} (3)

where Bₐ is the average distance of boundary a, B_{b} is the average distance of boundary b, B_{c} is the average distance of boundary c, and B_{d} is the average lo distance of boundary d. The average boundary distances B̅ᵢ are given by:

$${\overline{B}}_{i} = \frac{1}{{N}_{i}} \cdot {\sum }_{j = 1}^{{N}_{i}} Dist ( {P}_{{B}_{i} , j} , {P}_{0} ) \qquad ( 4 )$$

where i ∈ {a,b,c,d}, Nᵢ is the number of points on boundary i, P_{B}_{ᵢ}ⱼ is the location of the j^{th} point on boundary i, and P₀ is the location of the central point 42.

Another feature of the embodiment shown in FIG. 3 is that the average distance of each successively larger one of the boundaries a-d differs from the average distance of an adjacent preceding boundary in the series by a respective amount that decreases with each successively larger one of the boundaries a-d in the series. That is,

B̅_{b}− B̅ₐ> B̅_{c}− B̅_{b}> B̅_{d}− B̅_{c} (5)

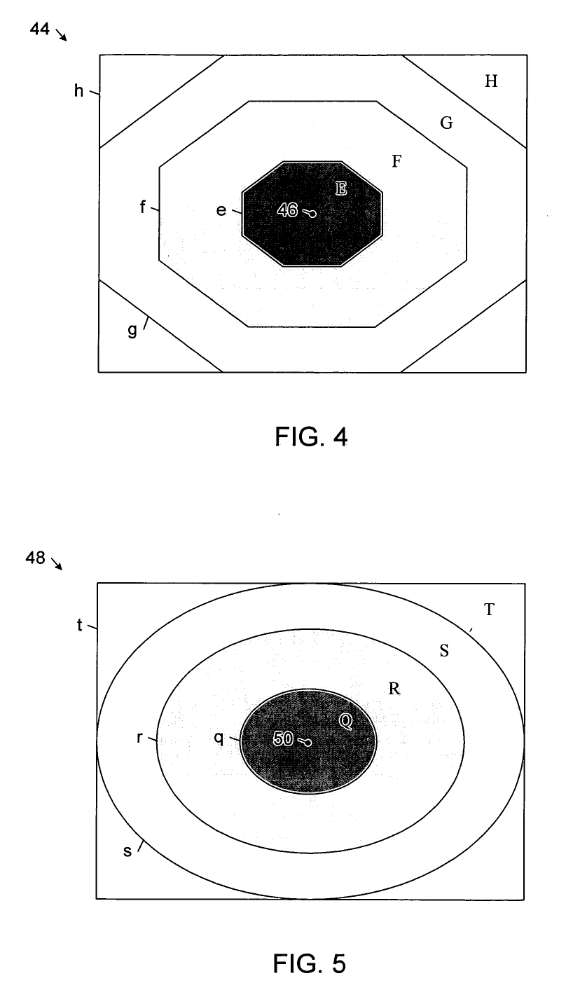

FIG. 4 shows an embodiment of a set of four partitions E, F, G, H into which an image 44 is divided. In this embodiment, the four partitions E-H are demarcated by a series of concentric octagonal boundaries e, f, g, h, where boundary h corresponds to the outer edges of the image 44. In the illustrated embodiment, the partition H corresponds to four discrete triangular regions at the outer corners of the image 44. Each of the partitions E-H includes a respective set of pixels that are located in the image 44 at respective coordinates whose average coincides with a central point 46 (e.g., the centroid) in the image 44. The partitions E-H have different respective average pixel distances ( P̅_{E}, P̅_{F}, P̅_{G}, P̅_{H}) from the central point in the image 44. The average pixel distances ( P̅_{E}, P̅_{F}, P̅_{G}, P̅_{H}) may be calculated using equations (1) and (2), where k ∈{E,F,G,H}.

The partitions E-H correspond to respective regions of the image 44 that are demarcated by the series of boundaries e, f, g, h, which are concentric about the central point 46. In the embodiment shown in FIG. 4, the series of boundaries e-h have successively larger average distances from the central point 46. That is:

B̅_{c}< B̅_{f}< B̅_{g}< B̅ₕ (6)

where Bₑ is the average distance of boundary e, B_{f} is the average distance of boundary f, B_{g} is the average distance of boundary g, Bₕ is the average distance of boundary h, and the average boundary distances B̅ᵢ may be calculated using equation (4), where i ∈{e, f, g, h}.

Another feature of the embodiment shown in FIG. 4 is that the average distance of each successively larger one of the boundaries e-h differs from the average distance of an adjacent preceding boundary in the series by a respective amount that decreases with each successively larger one of the boundaries e-h in the series. That is,

B̅_{f}− B̅ₑ> B̅_{g}− B̅_{f}> B̅ₕ− B̅_{g} (7)

FIG. 5 shows an embodiment of a set of four partitions Q, R, S, T into which an image 48 is divided. In this embodiment, the four partitions Q-T are demarcated by a series of concentric elliptical boundaries q, r, s, t, where boundary t corresponds to the outer edges of the image 48. In the illustrated embodiment, the partition T corresponds to four discrete regions at the outer corners of the image 48. Each of the partitions Q-T includes a respective set of pixels that are located in the image 48 at respective coordinates whose average coincides with a central point 50 (e.g., the centroid) in the image 48. The partitions Q-T have different respective average pixel distances ( P̅_{Q}, P̅_{R}, P̅_{S}, P̅_{T}) from the central point 50 in the image 48. The average pixel distances ( P̅_{Q}, P̅_{R}, P̅_{S}, P̅_{T}) may be calculated using equations (1) and (2), where I ∈{Q,R,S,T}.

The partitions Q-T correspond to respective regions of the image 48 that are demarcated by the series of boundaries q, r, s, t, which are concentric about the central point 50. In the embodiment shown in FIG. 5, the series of boundaries p-s have successively larger average distances from the central point 50. That is:

B̅_{q}< B̅ᵣ< B̅ₛ< B̅_{T} (8)

where B_{q} is the average distance of boundary q, Bᵣ is the average distance of boundary r, Bₛ is the average distance of boundary s, Bₜ is the average distance of boundary t, and the average boundary distances B̅ᵢ may be calculated using equation (4), where i ∈ {q, r, s, t}.

Another feature of the embodiment shown in FIG. 5 is that the average distance of each successively larger one of the boundaries q-t differs from the average distance of an adjacent preceding boundary in the series by a respective amount that decreases with each successively larger one of the boundaries q-t in the series. That is,

Bᵣ− B̅_{q}> B̅ₛ− B̅ᵣ> B̅ₜ− B̅ₛ (9)

### III. Calculating Motion Vectors

### A. Overview

The motion estimation module 16 determines a respective motion map (or motion correspondence map) for each pairing of the reference image 24 and a respective neighboring image. Each motion map includes a set of motion vectors u_{r,t} that map the pixels Pᵢ of partition of a neighboring image Iₜ to the pixels Pₜ of a corresponding partition of the reference image Iᵣ. As explained above, the motion estimation module 16 determines motion vectors 30 between corresponding partitions 26 of respective pairs of the images 12. In other embodiments, the motion estimation module 16 computes motion vectors between corresponding partitions of neighboring images and derives the motion vectors 26 between neighboring images and the reference image 24 from respective concatenations of the motion vectors that are computed for the intervening pairs of neighboring images between the respective neighboring images and the reference image 24. The motion vectors 26 may be computed for one or both of forward and backwards transitions between each of the neighboring images and the reference image 24.

In general, the motion estimation module 16 may compute the motion vectors 26 based on any type of motion model. In one embodiment, the motion vectors 26 are computed based on an affine motion model that describes motions that typically appear in image sequences, including translation, rotation, zoom, and shear. Affine motion is parameterized by six parameters as follows:

Uₓ(x,y)=aₓ₀+aₓ₁+aₓ₂y (10)

U_{y}(x,y)=a_{y0}+a_{y1}+a_{y2}y (11)

where Uₓ(x,y) and U_{y}(x,y) are the x and y components of a velocity motion vector at point (x,y), respectively, and the aₖ's are the affine motion parameters. The motion maps of image pairs may be represented as vector fields in the coordinate system of the reference image. A vector field U(P), the reference image Iᵣ(P), and the neighboring image Iₜ(P) (e.g., one of the images preceding or succeeding the image to be enhanced in a image sequence), satisfy the following condition:

Iᵣ(P)=Iₜ(P−U(P)) (12)

where P=P(x, y) represents pixel coordinates.

### B. Multiresolution Image Pyramid Based Approach for Calculating Motion Vectors

In some embodiments, the motion estimation module 16 generates a respective multiresolution image pyramid for each of the divided images 12 and iteratively determines the motion vectors 30 between corresponding partitions of respective pairs of the images at each level of the respective multiresolution image pyramids from a coarse resolution level to a fine resolution level.

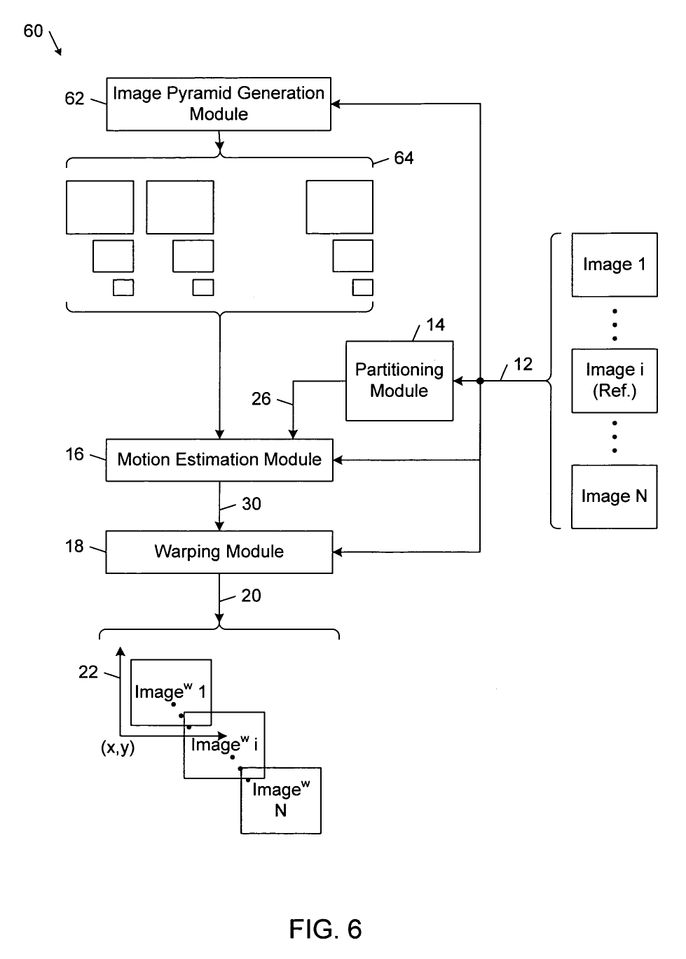

FIG. 6 shows an embodiment 60 of the image processing system 10 that includes an image pyramid generation module 62 that generates respective multiresolution image pyramids 64 from the images 12. In this embodiment, the r images are represented by Laplacian multiresolution pyramids or Gaussian multiresolution pyramids. The motion estimation module 16 computes the motion vectors 30 using a pyramid-based hierarchical image alignment technique to derive the motion vectors 30 that align the partitions of each neighboring image with the corresponding partitions of the designated reference image 24 in the reference coordinate system 22.

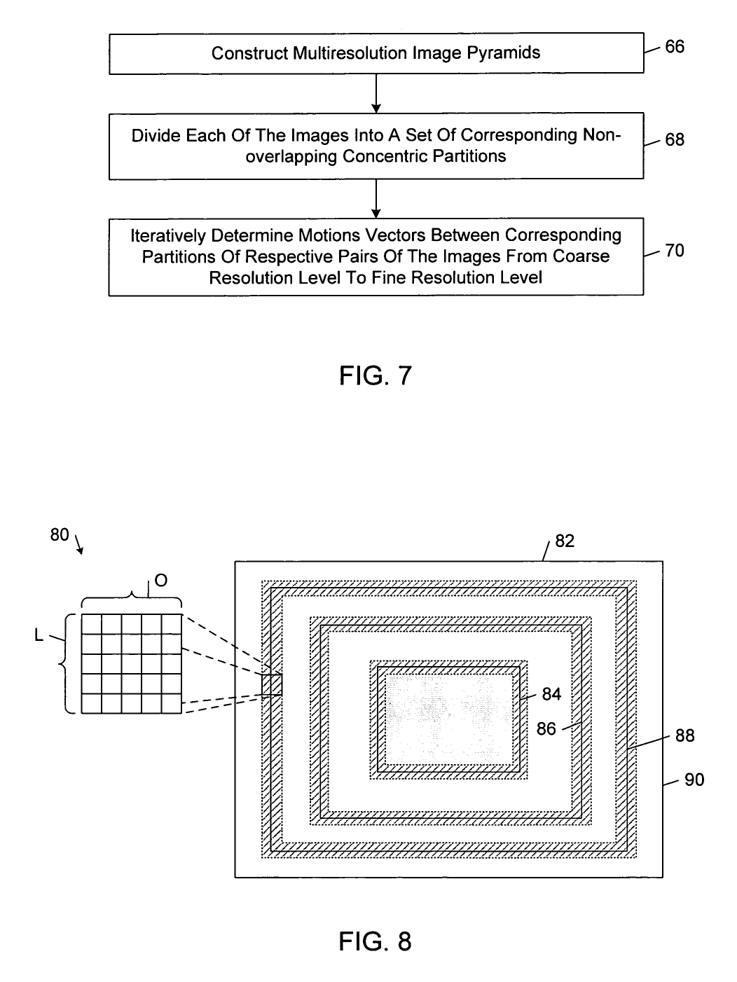

FIG. 7 shows a flow diagram of an embodiment of a method by which the embodiment 60 computes the motion vectors 30.

In accordance with this method, the image pyramid generation module 62 (shown in FIG. 6) constructs the Laplacian or Gaussian multiresolution image pyramids 64 from the images 12 (FIG. 7, block 66). The partitioning module 14 divides each of the images 12 into a set of corresponding non-overlapping concentric partitions 26 (shown by an arrow in FIG. 6) (FIG. 7, block 68). The motion estimation module 16 iteratively computes motion vectors between corresponding partitions of respective pairs of the images from a coarse resolution level to a fine resolution level (FIG. 7, block 70). In this process, the sum of squared differences (SSD) measure, integrated over a selected partition, typically is used as a match measure within each pyramid level:

$$E ( U ( P ) ) = {\sum }_{P} {( {I}_{r} ( P ) - {I}_{t} ( P - U ( P ) ) )}^{2} \qquad ( 13 )$$

where E(U(P)) is the SSD error associated with motion vector field U(P) and I is the Laplacian or Gaussian filtered image value. The sum is computed over all the points P within the selected partition and is used to denote the SSD error of the entire motion field within that partition.

Numerical methods, such as Gauss-Newton minimization, typically are applied to the objective function described in equation (13) in order to estimate the unknown motion parameters and the resulting motion vectors. Starting with some initial values (typically zero), the hierarchical motion estimation algorithm iteratively refines the parameters in order to minimize the SSD error described in equation (13) from coarse to fine resolutions. After each motion estimation step, the current set of parameters is used to warp the neighboring image to the coordinate frame of the reference image 24 in accordance with the transformation defined in equation (12), in order to reduce the residual displacement error between the images.

In some embodiments, the motion estimation module 16 compensates for brightness variations across multiple exposure images by normalizing the images 12 at each pyramid resolution level. In some of these embodiments, the motion estimation module 16 performs intensity equalization at each resolution level of image pyramids before estimating the motion vectors. In this process, the motion estimate module 14 normalizes the multiresolution images to remove global changes in mean intensity and contrast. In other ones of the embodiments, the motion estimation module 16 applies local contrast normalizations at each resolution level of the image pyramids before estimating the motion vectors 26.

In some embodiments, the motion estimation module 16 performs contrast normalization by stretching the histogram of brightness values in each image over the available brightness range. In this process, the brightness values in a given image are mapped over a range of values from 0 to 2^{B}−1, which are defined as the minimum and the maximum brightness of the available intensity range, respectively. In one embodiment, brightness values are mapped over the available range in accordance with the general transformation defined in equation (14):

$$b [ m , n ] = \{ \begin{matrix} 0 & a [ m , n ] \leq {p}_{low} \\ ( {2}^{B} - 1 ) \cdot \frac{a [ m , n ] - {p}_{low}}{{p}_{high} - {p}_{low}} & {p}_{low} < a [ m , n ] < {p}_{high} \\ {2}^{B} - 1 & a [ m , n ] \geq {p}_{high}\end{matrix} \qquad ( 14 )$$

In equation (14), p_{low} and p_{high} represent predefined or user-defined brightness values within the available range. For example, in some implementations, the p_{low} may be set to the brightness value corresponding to the 1% value of the available range and p_{high} may be set to the brightness value corresponding to the 99% value of the available range. When p_{low} and p_{high} are set to the maximum and minimum brightness values of the available range, the transformation of equation (14) may be expressed as:

$$b [ m , n ] = ( {2}^{B} - 1 ) \cdot \frac{a [ m , n ] - minimum}{maximum - minimum} \qquad ( 15 )$$

In some embodiments, the motion estimation module 16 performs intensity equalization in accordance with a histogram equalization process in accordance with which the intensity histograms of the images are normalized to a “standard” histogram. In one exemplary implementation, the intensity histogram of each of the images is mapped into a quantized probability function that is normalized over the range of values from 0 to 2^{B}−1, which correspond to the minimum and the maximum brightness of the available intensity range, respectively.

In some embodiments, the motion estimation module 16 initially computes a global motion vector for each pair of images 12. The global motion vectors are used as a starting point for the motion estimation module 16 to iteratively compute motion vectors for the partitions from a coarse resolution level to a fine resolution level in accordance with block 70 of the method shown in FIG. 7. The process of computing the global motion vectors is similar to the iterative process of computing the partition motion vectors described above, except that the motion vectors are computed for global regions of the neighboring images (typically the entire images), instead of the concentric partitions.

The motion estimation approach described above is able to accommodate a wide range of displacements, while avoiding excessive use of computational resources and generation of false matches. In particular, using a multiresolution pyramid approach allows large displacements to be computed at low spatial resolution. Images at higher spatial resolution are used to improve the accuracy of displacement estimation by incrementally estimating finer displacements. Another advantage of using image pyramids is the reduction of false matches, which is caused mainly by the mismatches at higher resolutions under large motion. Motion estimation in a multiresolution framework helps to eliminate problems of this type, since larger displacements are computed using images of lower spatial resolution, where they become small displacements due to sub-sampling.

### IV. Warping the Images

The warping module 18 warps each of the neighboring images to the reference coordinate system 22 (e.g., the coordinate system of the reference image 24 in the illustrated embodiments) in accordance with the following transformation, which is derived from equation (12) above:

Iₜ^{w}(P)=Iₜ(P−U(P)) (16)

where Iₜ^{w}(P) is the warped neighboring image.

### V. Post-Processing the Warped Images

In general, the resulting set of spatially aligned warped images 20 may be compared or integrated for a wide variety of different applications, including computer vision, pattern recognition, medical image analysis, and remote sensing data fusion.

In some embodiments, before the warped images are compared or combined, a local intensity smoothing filter is applied to local regions of the warped images 20 that correspond to the concentric partition boundaries that demarcated the partitions for which the motion vectors 30 were determined. In some cases, such an intensity smoothing filter may reduce artifacts that might be introduced as a result of imperfect alignment between the partitions and the pixel regions in the images that are similarly affected by the dominant type of radial lens distortion in the images 12.

FIG. 8 shows a local intensity smoothing filter being applied to local regions (shown by cross-hatching) of a warped image 82 corresponding to a set of concentric partition boundaries 84, 86, 88, 90 that were used to derive the warped image 82 in accordance with one or more of the embodiments described above. In general, the smoothing filter may be any type of two dimensional low-pass filter. In one embodiment, the smoothing filter is a two-dimensional Gaussian smoothing filter that is characterized by a kernel 80 having a size corresponding to L rows of pixels and L columns of pixels, where L is an integer value greater than 1. The kernel 80 typically is smaller than a smallest distance between adjacent ones of the concentric partition boundaries 84-90 so as to avoid smoothing across multiple ones of the boundaries 84-90. In the illustrated embodiment, the kernel 80 has an exemplary size of 5×5 pixels.

### VI. Conclusion

The image processing embodiments that are described in detail above are able to register images in ways that reduce the misregistration effects caused by radial lens distortion. In these embodiments, the images are warped to a common reference coordinate system in accordance with motion vectors that are determined for non-overlapping concentric partitions of the images. The concentric image partitions approximate pixel regions in the images that are similarly affected by the dominant type of radial distortion that is caused by typical optical lenses. In this way, the embodiments that are described herein are able to efficiently and effectively achieve accurate image registration in the presence of lens distortion without requiring pixel-wise motion computation.

Other embodiments are within the scope of the claims.

What is claimed is:

1. A method of processing images, comprising:
dividing each of the images into a set of corresponding non-overlapping concentric partitions, each of the partitions comprising a respective set of pixels distributed about a central point in the corresponding image;
determining motion vectors between corresponding partitions of respective pairs of the images; and
warping ones of the images to a reference coordinate system based on the motion vectors.

2. The method of claim 1, wherein each of the partitions comprises a respective set of pixels located in the corresponding image at respective coordinates whose average coincides with the central point in the corresponding image.

3. The method of claim 1, wherein the dividing comprises dividing each of the images so that the corresponding partitions have different respective average pixel distances from the central point in the corresponding image.

4. The method of claim 3, wherein the dividing comprises demarcating the partitions with a series of boundaries that are concentric about the central points of the corresponding images.

5. The method of claim 4, wherein the demarcating comprises demarcating the partitions with a series of concentric polygonal boundaries.

6. The method of claim 5, wherein the demarcating comprises demarcating the partitions with a series of concentric rectangular boundaries.

7. The method of claim 4, wherein the demarcating comprises demarcating the partitions with a series of concentric elliptical boundaries.

8. The method of claim 4, wherein the demarcating comprises demarcating the partitions with a series of boundaries having successively larger average distances from the central point of the corresponding image.

9. The method of claim 8, wherein the average distance of each successively larger one of the boundaries differs from the average distance of an adjacent preceding boundary in the series by a respective amount that decreases with each successively larger one of the boundaries in the series.

10. The method of claim 4, further comprising applying a local intensity smoothing filter to local regions of the warped images corresponding to the concentric partition boundaries, wherein the local intensity smoothing filter has a kernel smaller than a smallest distance between adjacent ones of the concentric partition boundaries.

11. The method of claim 1, further comprising generating a respective multiresolution image pyramid for each of the divided images, and the determining of image motion comprises iteratively determining the motion vectors between corresponding partitions of respective pairs of the images at each level of the respective multiresolution image pyramids from a coarse resolution level to a fine resolution level.

12. A system for processing images, comprising:
a partitioning module operable to divide each of the images into a set of corresponding non-overlapping concentric partitions, each of the partitions comprising a respective set of pixels distributed about a central point in the corresponding image;
a motion estimation module operable to determine motion vectors between corresponding partitions of respective pairs of the images; and
a warping module operable to warp ones of the images to a reference coordinate system based on the motion vectors.

13. The system of claim 12, wherein each of the partitions comprises a respective set of pixels located in the corresponding image at respective coordinates whose average coincides with the central point in the corresponding image.

14. The system of claim 12, wherein the partitioning module is operable to divide each of the images so that the corresponding partitions have different respective average pixel distances from the central point in the corresponding image, and to demarcate the partitions with a series of boundaries that are concentric about the central points of the corresponding images.

15. The system of claim 14, wherein the partitioning module is operable to demarcate the partitions with a series of concentric boundaries selected from the group consisting of concentric polygonal boundaries, concentric rectangular boundaries, and concentric elliptical boundaries.

16. The system of claim 14, wherein the partitioning module is operable to demarcate the partitions with a series of boundaries having successively larger average distances from the central point of the corresponding image.

17. The system of claim 16, wherein the average distance of each successively larger one of the boundaries differs from the average distance of an adjacent preceding boundary in the series by a respective amount that decreases with each successively larger one of the boundaries in the series.

18. The system of claim 14, further comprising a filtering module operable to apply a local intensity smoothing filter to local regions of the warped images corresponding to the concentric partition boundaries, wherein the local intensity smoothing filter has a kernel smaller than a smallest distance between adjacent ones of the concentric partition boundaries.

19. A machine-readable medium storing machine-readable instructions causing a machine to perform operations comprising:
dividing each of the images into a set of corresponding non-overlapping concentric partitions, each of the partitions comprising a respective set of pixels distributed about a central point in the corresponding image;
determining motion vectors between corresponding partitions of respective pairs of the images; and
warping ones of the images to a reference coordinate system based on the motion vectors.

20. The machine-readable medium of claim 19, wherein the machine-readable instructions cause the machine to divide each of the images so that the corresponding partitions have different respective average pixel distances from the central point in the corresponding image, and to demarcate the partitions with a series of boundaries that are concentric about the central points of the corresponding images.
